(19) United States
(12) Patent Application Publication
(10) Pub. No.: US 2003/0008031 A1
(43) Pub. Date: Jan. 9, 2003

(54) Container for convenient dispensing of semi-solid foods

(76) Inventors: Nathan L. Feldman, Deerfield Beach, FL (US); Stephen Screnci, Boca Raton, FL (US)

Correspondence Address: MELVIN K. SILVERMAN, SUITE 440, 4901 NORTH FEDERAL HIGHWAY, FORT LAUDERDALE, FL, 33308, US

(21) Appl. No.: 09/899,789

(22) Filed: Jul. 6, 2001

(51) Int. Cl. A23B 4/00

(52) U.S. Cl. 425/208

(57) ABSTRACT

A system for the convenient discharge of a non-liquid comestible from a container includes a substantially unitary cylindrical sleeve formed of a substantially rigid material, the sleeve defined about a longitudinal axis and having first and second ends. A first base of the system is formed of a substantially rigid material and is defined by a radial cross-section of the sleeve. A periphery of the base is secured in integral communication with the sleeve proximally to the first end of the axis thereof. A quantity of the comestible is disposed within the sleeve and against the first base. A wafer-like piston is disposed co-axially with the sleeve, an interior surface of which is in contact with the comestible, the piston disposed in press-slidable complemental relationship to an interior surface of the sleeve. The piston defines a second base at a second end of the sleeve axis, and is secured in fluid tight relationship to the sleeve between the sleeve proximally to the second end of the axis. Circumferential means provide for manual release of the piston from the sleeve.

### BACKGROUND OF THE INVENTION

1. Area of Invention

The invention relates to food containers, both metallic and polymeric, adapted for the holding of semi-solid foods and comestibles within a sealed container.

2. Prior Art

The use of hermetically sealed cans as a medium of storing a vast variety of foods and comestibles has been known for almost 100 years and has become a mainstay for the storage and marketing of foods of many types during the last sixty years. Where the food to be stored, marketed, and ultimately dispensed by the consumer is rigid or sold, this medium of storage has proved to be remarkably successful. However, where the comestible is semi-solid, as is the case with food products such as cream, condensed soups, frozen juice concentrates, re-fried beans, and pet foods, these substances exhibit a pasty or gooey consistency that render them difficult to empty the contents thereof, this sometimes even with the use of a kitchen utensil such as a spoon or fork. This secondary step, which must often follow the opening of the can per se, operates to reduce in part the “convenience factor” associated with a consumer's decision to purchase the containerized food in the first place. As such, from both the perspective of consumer convenience and that of companies marketing such products, a need has long existed in the art for an improved container for the dispensing of semi-solid or soft foods.

Solutions to this problem which have appeared in the art are reflected in U.S. Pat. No. 4,090,646 (1978) to Dubiel, et al, entitled Soft Food Dispenser; U.S. Pat. No. 4,883,198 (1989) to Manaska, entitled Container And Method For Dispensing Semi-solid Substances; U.S. Pat. No. 5,111,973 (1992) to Mueller, entitled Discharge Device For Dispensing Container; U.S. Pat. No. 5,650,180 (1997) to Kumada, et al, entitled Dispenser For Paste-type Material; and U.S. Pat. No. 5,692,632 (1997) to Hsieh, et al, entitled Container With Self-contained Evacuation Lid. Solutions to this problem that are particular to pet food and pet food cans appear in U.S. Pat. No. 4,706,849 (1987) to Ryan, entitled Device For Dispensing A Pet Food From A Sealed Can Container Therefore; U.S. Pat. No. 5,009,310 (1991) to Finnery, entitled Disposable Container For Storing And Dispensing Pet Food; and U.S. Pat. No. 5,695,086 (1977) to Viola, entitled Closure Device For Pet Food Cans. All of the above prior art, as well as all other art known to the within inventors, rely upon structures having internal mechanical complexity, or rely upon a delicate balance of external to internal air pressure, relative to the inherent properties of viscosity and cohesiveness of the semi-solid substance to be dispensed, for the proper operation thereof. Also, the prior art does not take into account the potential utility of polymeric materials for use, either in whole or part, as an element of a system for the convenient dispensing of a semi-solid or soft food. It is in response to long felt needs in the art of this type that the instant invention is directed.

### SUMMARY OF THE INVENTION

The present invention comprises a system for the dispensing of a semi-solid comestible from a sealed container in which the system comprises a substantially unitary sidewall in the nature of a cylindrical sleeve formed of a substantially rigid material. Said sleeve is defined about a longitudinal axis having first and second ends thereof. The system also includes a first base formed of a substantially rigid material, said base defined by a radial cross-section of said sleeve. The periphery of said first base is secured in integral fluid tight communication with said sleeve proximally to said first end of said axis. Further provided is means for enabling a selectable separation of said first base from said sleeve.

A quantity of the semi-solid comestible is disposed within said sleeve and against said first base. A wafer-like piston, preferably formed of a hygienic polymeric material, having a width in the direction of said sleeve axis in a range of about one to about five centimeters is disposed co-axially with said sleeve upon a side of said comestible opposite to said first base and in press-slidable complemental relationship with the interior walls of said sleeve. At said second end of said sleeve axis is provided a second base having a periphery which is substantially complemental to an opposing periphery of said sleeve and is secured in substantially fluid-tight relationship thereto. Various means may be provided to effect a selectable release of the second base from said opposing periphery of the sleeve, thereby permitting the consumer to apply manual pressure against said wafer-like piston, after said first base has been separated from the sleeve, to advance said piston along said axis to conveniently eject the semi-solid contents of the container.

It is accordingly an object of the present invention to provide an improved container and method for the dispensing of soft and semi-solid food products.

It is another object to provide a means for the serving of semi-solid food in an expeditious manner without requirement for use of a kitchen utensil to empty the container.

It is a further object to provide a container of the above type having particular application to pet food that are manufactured and marketed in a hermetically sealed container.

The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 is an exploded conceptual view of the inventive system in which essentially all elements of the system are formed of polymeric materials.

FIG. 1A is an alternate embodiment to that of FIG. 1.

FIG. 2 is a concept drawing showing the extrusion of the food to be dispensed after removal of the upper and lower bases of the system of FIG. 1 of 1A.

FIG. 3 is an exploded view of a further embodiment of the inventive system showing the use of longitudinal ribs and channels to improve stability of the piston element of the system.

FIG. 4 is a radial cross-sectional view of the cylindrical sleeve shown in FIG. 3.

FIG. 5 is a top plan view of the piston element shown in FIG. 3.

FIG. 6 is a perspective assembly view showing the embodiment of FIGS. 3 to 5 before the top and bottom bases thereof have been removed.

FIGS. 7 and 8 are sequential views showing use of a further embodiment of the invention.

FIG. 9 and 10 are sequential views showing a yet further embodiment and its use.

### DETAILED DESCRIPTION OF THE INVENTION

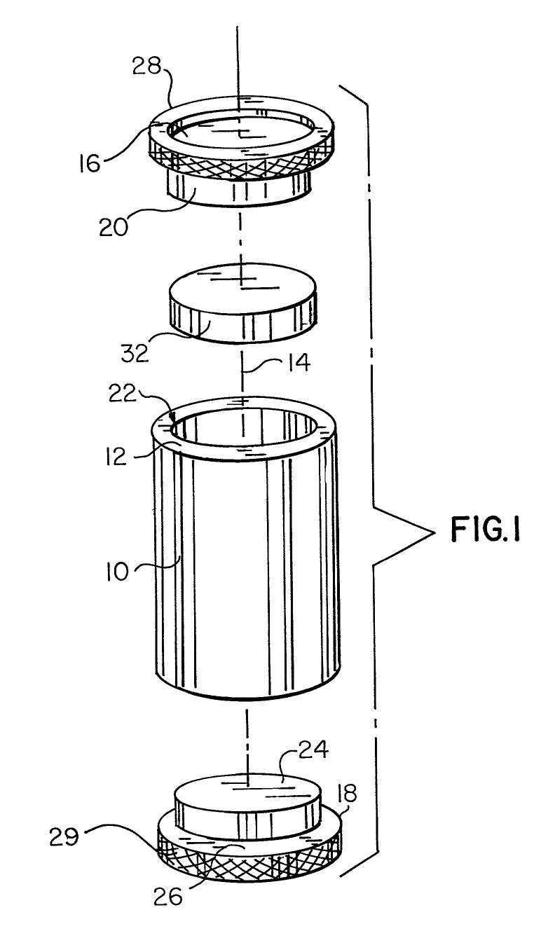

With respect to the exploded view of FIG. 1, the inventive system may be seen to include a unitary cylindrical sleeve 10 which, when formed of an FDA grade approved polymer, such as Delran or polyurethane, will typically have an annular or radial width 12 of about one centimeter. It is to be understood that the axial dimension of the system, as defined by sleeve axis 14, may vary considerably, this in accordance with the type of semi-solid food to be contained within the system. For example, with a comestible such as cat food or tuna, the length of axis 14 will of course be considerably smaller than would be the case where the system is used in the containment of a juice concentrate or a thick cream.

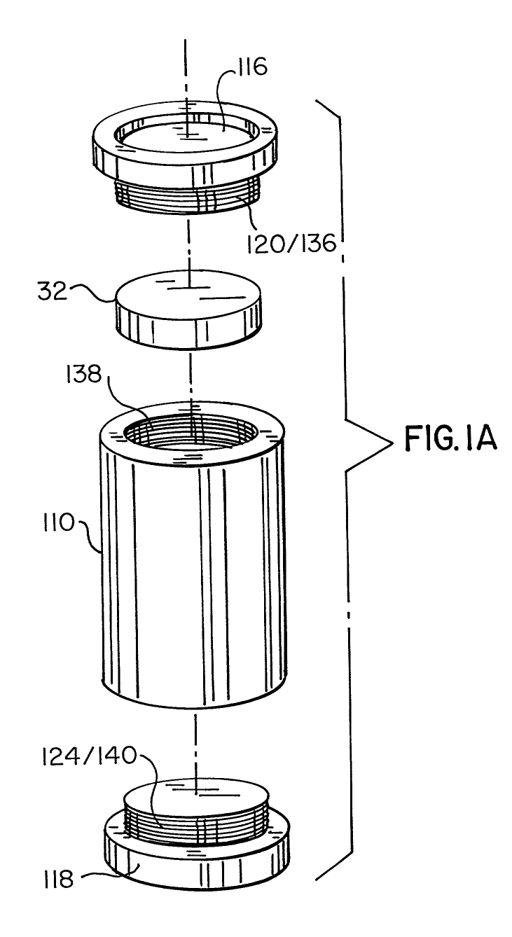

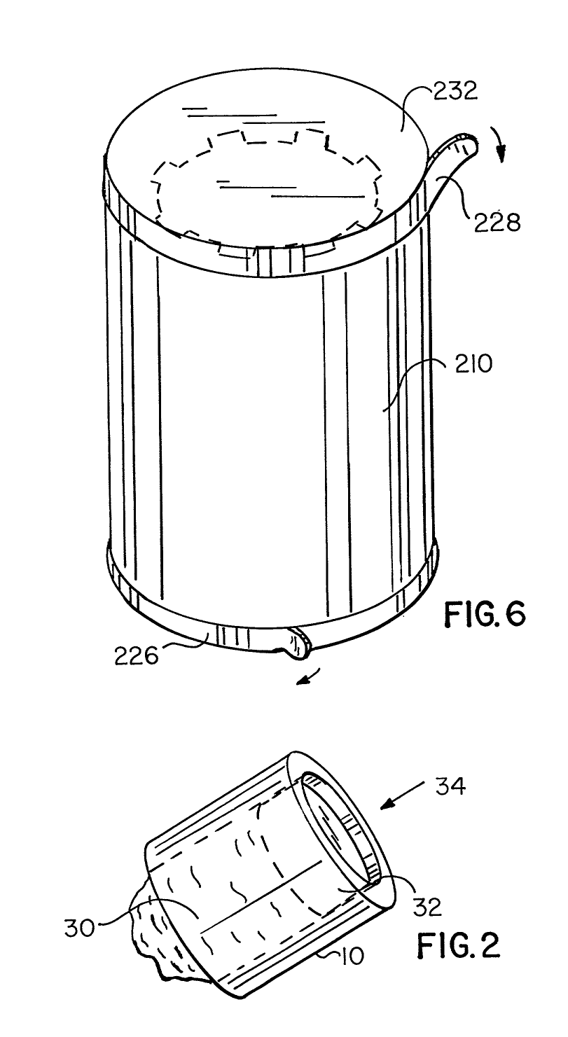

The system is further characterized by a first or upper base 16 and a second or lower base 18, the edges of which may be knurled. In this embodiment, as well as others described below, said first base must be provided with some means for assuring a hermetic seal of the food to be contained within the system. This may be achieved by any one of a number of means, one of which is shown in the exploded view of FIG. 1 as a fluid tight circumferential elastomeric strip seal 28. Further, upper base 16 is provided with an integral axial plug 20 which is proportioned for press-fittable engagement with interior diameter 22 of the container sleeve 10. In this embodiment, bottom base 18 is substantially identical to upper base 16 and, thereby, is provided with integral plug 24 which, as with said plug 20, is proportioned for press fittable engagement with inner diameter 22 of the sleeve. Thereby, following the removal of a hermetic seal strip 26 (similar to seal 28) (which assures fluid tight communication between lower base 18 and sleeve 10), a user of the present system may manually pull the lower base 18 out of sleeve 10 by simply engaging and twisting its knurled sidewalls 29 relative to sleeve 10, whereby the stored comestible 30 (see FIG. 2) becomes visible. The user then inverts the system, with a plate or tray therebeneath to receive the food to be dispensed and, thereupon, removes circumferential seal 28 associated with upper base 16, whereupon the user will similarly lift or twist upper base 16 and its associated axial plug 20 out of the upper area of sleeve 10. When this is accomplished, the user will observe a wafer-like piston 32 which is formed of an FDA grade approved polymeric material. The piston 32 is provided with an axial width in a range of about one to about five centimeters, is disposed co-axially with sleeve axis 14 and is disposed upon the side of said comestible which is opposite to that of said first base. Further, piston 32 must be in press-slidable complemental relationship to the interior walls of sleeve 10 to assure that the comestible is not able to seep or squirt backward in the direction of the user. The use of the piston is more particularly shown in FIG. 2 which shows the application of pressure, indicated by arrow 34, against wafer-like piston 32 to effect a convenient and orderly discharge of the food 30 out of the lower end of sleeve 10, which corresponds to a lower end of said sleeve axis 14.

In the embodiment of FIG. 1A is shown a system, substantially similar to that of FIG. 1, except that plug 120 of upper base 116 is provided with spiral threading 136 which is complemental to spiral threading 138 provided upon the interior surface of sleeve 110. In like fashion, axial plug 124 of lower base 118 is provided with spiral threading 140 which is complemental to threading provided at a lower portion of the interior of sleeve 110. Where such spiral threading is employed, the natural seal accomplished between the mating surfaces of plugs 120 and 124 against the interior sidewalls of sleeve 110 may be sufficient to avoid the need for a circumferential seal in the nature of said seals 26 and 28 associated with respective lower and uppers bases in the embodiment of FIG. 1. This may particularly be the case with pet foods and other foods, such as juice concentrates, where the hygienic risk is not sufficient to justify the requirement of such circumferential seals at the top and/or bottom of the system.

In the embodiment of FIG. 1A, the system is used in identical fashion to that of FIG. 2 after removal of the top and bottom bases

It is to be understood that the above-described embodiments may also be practiced in non-polymeric materials including, for example, the historic tin can. Therein the only significant addition thereto is that of wafer-like piston 32 such that, after the can has been opened on one side through the use of a traditional can opener and inverted, the other side of the can is then opened while a dish or pan is kept under the opened side thereof. After both the bottom and top of the traditional tin can has been removed, as by a can opener, piston 32 is pushed to accomplish a convenient dispensing of the contents thereof.

The invention is fully applicable to systems having a pop-open or pull-open top and/or bottom. If, for example, only the top of the structure is provided with a pop open or pull open means, then a traditional can opener can be used on the traditionally weld-sealed side of the can which is then inverted in that direction. Thereafter the pop-open or pull-open top of the can is removed, thereby enabling the user to manually reach like piston 32 and to advance the same downwardly in the fashion shown in FIG. 2.

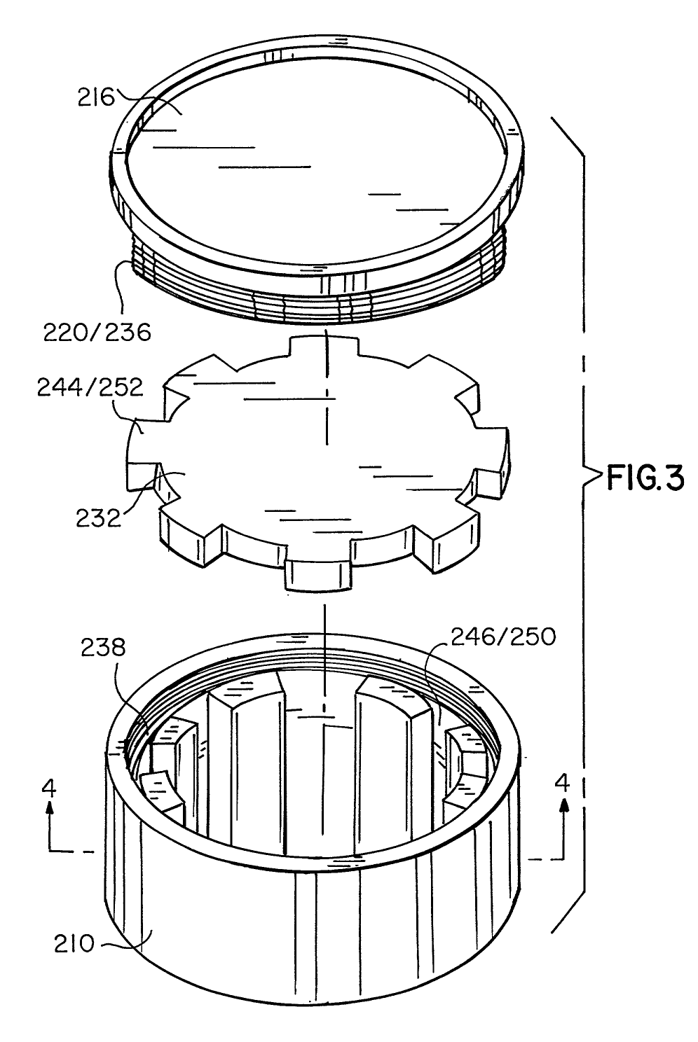

In FIG. 3 is shown a variation of the above embodiments which offers therefrom only in the provision of an interdigitating geometry of peripheral elements 244 of piston 232 with that of the interior surface 246 of sleeve 210. In other words, to assure a more reliable and precise piston-like motion of piston 232 relative to the interior of sleeve 210, there is provided a plurality of longitudinal channels 250 that are complemental to radial projections 252 of the piston 232. This design, taken in combination with an axial width in a range of one to five centimeters of the piston 232, assures complete stability of the piston 232 relative to sleeve 210. The areas of upper entry and lower exit to sleeve 210 may, in the nature of the embodiment of FIG. 1A, be provided with thread means 238 which are proportioned for complemental receipt of thread means 236 of plug 220 of base 216. A similar strategy may be employed with respect to bottom base (not shown) of the embodiment of FIG. 3 if a tear-off or pull-off base release is not employed.

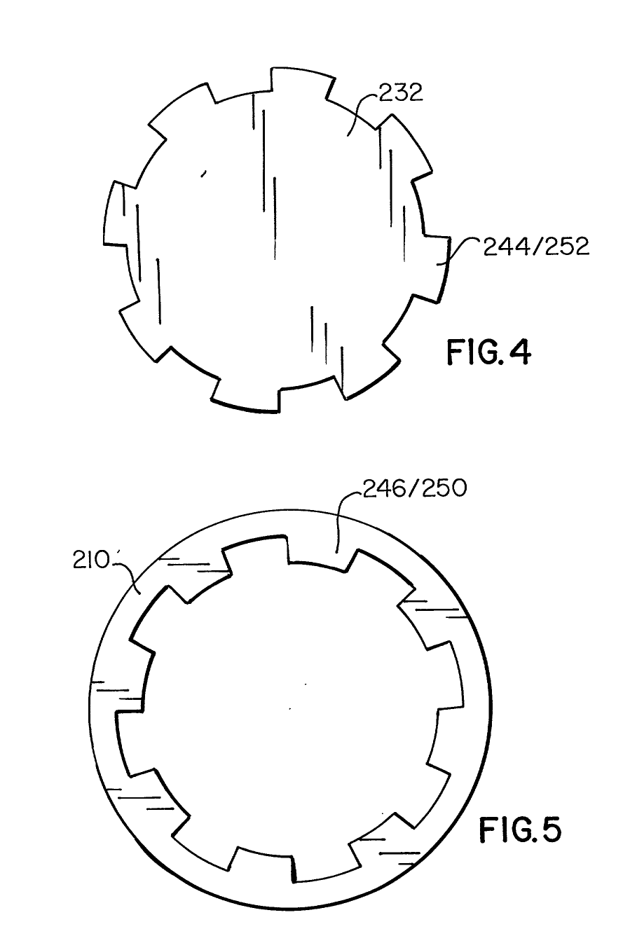

FIG. 4 is a radial cross-sectional view of FIG. 3 taken along Line 4-4 thereof, while FIG. 5 is a plan axial view of the wafer-like piston 232 shown in the exploded view of FIG. 3. FIG. 6 is an assembly view of FIG. 3 in which the sidewall of sleeve 210 is shown with a larger annular width, as might be appropriate if the container is used as an insulator. Also shown are optional sealing strips 226 and 228.

As noted, it is to be understood that the above described means for assuring fluid tight closure of the top and bottom bases relative to the cylindrical sleeve may be mixed and matched for the top of a given container versus the bottom thereof, in accordance with any of a number of packaging, transportation, regulatory, and marketing considerations, as may the materials of the system component. For example, in the use of juice concentrates, which are typically sold in a cardboard container, a structure in the nature of piston 32 may be included without significant modification of the cardboard configuration of the sleeve, except as to thickness.

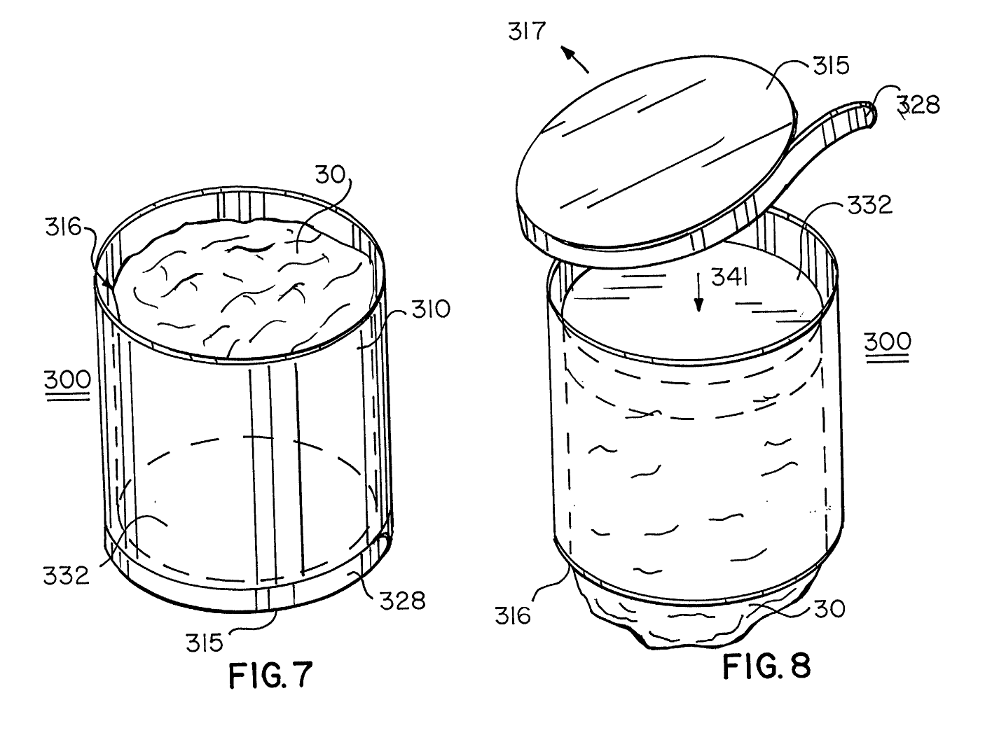

It is to be appreciated that in a further embodiment, the first base and the wafer of FIG. 1 or 3 may be merged into a single element such that, upon release of a suitable seal, it may be pushed through the entire sleeve. For example, with reference to FIG. 7, there is shown the application of the invention to an otherwise conventional metallic can 300. More particularly, in FIG. 7 there is shown the can in its upright position in which the upper base thereof has already been removed such that food 30 within the cylindrical sleeve 310 of the can is visible. It is noted that food 30 fills sleeve 310 up to level 316. At the bottom of can 300 is piston 332, the periphery of which is hermetically sealed to the circumference of the bottom of the can by a removable cap 315 that may include tab strip 328. This functions both to stabilize piston 332 relative to sleeve 310 and to provide necessary sealing and fluid integrity between the interior and exterior of the can.

In FIG. 8, can 300 is shown inverted and the removal of preferably plastic cap 315 (se arrow 317) and its top strip seal 328 is removed. After the removal of strip 328, whether, with or without the inclusion of plastic cover 315, the piston seal 332 is then visible to the user. Thereupon, the user will urge upon piston 332 in direction shown by arrow 341, this resulting in the extrusion of the food 30 from sleeve 310 and entirely out of can 300 and onto an appropriate serving dish. It may thereby be appreciated that the present invention is equally applicable to use with conventional tin cans as it is to use with containers formed of a polymeric material and having a greater wall thickness as shown above with reference to the embodiments if FIGS. 1 through 6.

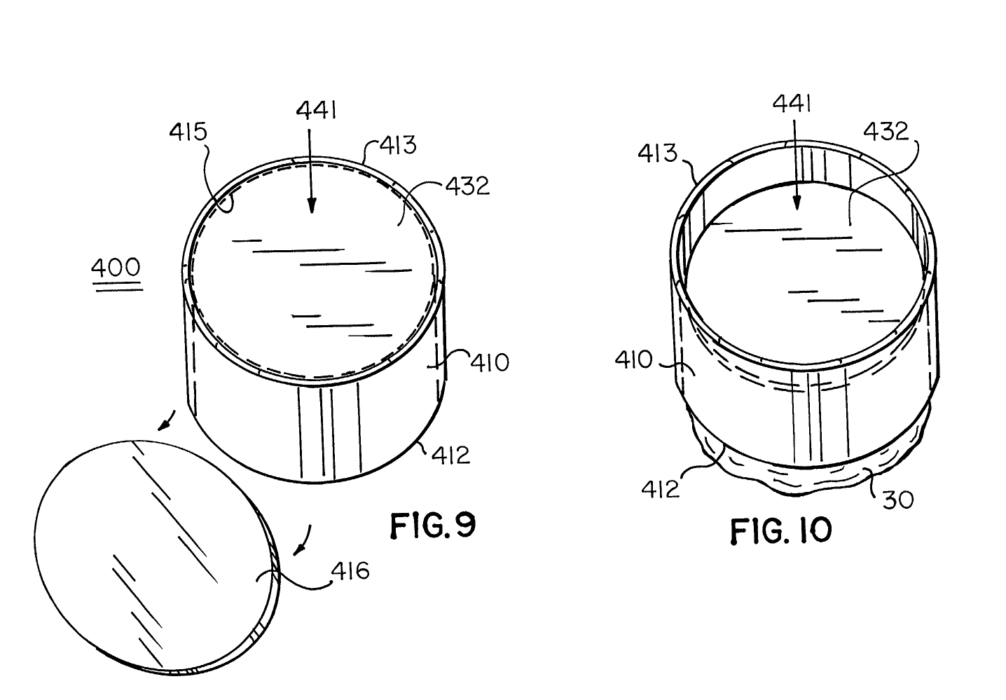

In FIGS. 9 and 10 are shown a yet further embodiment 400 of the invention, the form of which, as in the preceding embodiment, relates to an otherwise ordinarily appearing tin can for food. Therein, top base of 416 has been removed from the can top 412 in a conventional fashion, that is, via a can opener or pop top opening. Thereafter, lower base 432 is pushed, as is indicated by force arrow 441, from lower edge 413 of the can 400. Lower base 432 is secured to lower edge 413 by means of a perforated or scored circumference 415 such that the application of force 441 will cause a fracture of the circumference 415 and, thereby, the downward advance of lower base 432 in the fashion shown in FIG. 10. This will result in the discharge of the food 30 of the can 400 into a plate or other serving means as may be desired by the user. In the embodiments of FIGS. 9 and 10, it is anticipated that a plastic cap in the nature of cap 315 shown in the embodiment of FIGS. 8 would be employed in order to ensure bacterial integrity of the contents of the can.

It is noted that the present invention may also be employed with solid foods of various types.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

We claim:

1. A system for the convenient dispensing of a semi-solid comestible from a sealed container, comprising:
(a) a substantially unitary cylindrical sleeve formed of a substantially rigid material, said sleeve defined about a longitudinal axis having first and second ends thereof;
(b) a first base formed of a substantially rigid material, said base defined by a radial cross-section of said sleeve, the periphery of said base secured in integral communication with said sleeve proximally to said first end of said axis thereof;
(c) means for enabling a selectable separation of said first base from said sleeve;
(d) a quantity of said comestible disposed within said sleeve and against said first base;
(e) a wafer-like piston having a width in a range of about one to about five centimeters disposed co-axially within said sleeve upon a side of said comestible opposite said first base, and said piston further disposed in press-slidable complemental relationship to interior walls of said sleeve;
(f) a second base at said second end of said sleeve axis, having a periphery substantially complemental to an opposing periphery of said sleeve, and secured in substantially fluid tight relationship thereto; and
(g) means for selectable release of the periphery of said second base from said sleeve.

2. The system as recited in claim 1, in which said second base comprises a foil-like or metallic material.

3. The system as recited in claim 1, in which said sleeve comprises a metal or alloy thereof.

4. The system as recited in claim 1, in which said piston comprises a polymeric material.

5. The system as recited in claim 3, in which said piston comprises a polymeric material.

6. The system as recited in claim 4, in which said sleeve comprises a polymeric material having an annular width of at least 0.5 centimeters.

7. The system as recited in claim 4, in which each of said bases comprise a polymeric material.

8. The system as recited in claim 1 in which:
said sleeve includes a plurality of longitudinal channels within an interior surface thereof disposed co-axially about said axis;
and
said piston comprises a plurality of axial protrusions each complemental to a corresponding one of said longitudinal channels within said sleeve.

9. The system as recited in claim 5, in which said second base comprises a foil-like or metallic material.

10. The system as recited in claim 7, in which said sleeve comprises a metal or alloy thereof.

11. A system for the convenient discharge of a non-liquid comestible from a container, comprising:
(a) a substantially unitary cylindrical sleeve formed of a substantially rigid material, said sleeve defined about a longitudinal axis, having first and second ends thereof;
(b) a first base formed of a substantially rigid material, said base defined by a radial cross-section of said sleeve, a periphery of said base secured in integral communication with said sleeve proximally to said first end of said axis thereof;
(c) a quantity of said comestible disposed within said sleeve about said axis and against said first base;
(d) a wafer-like piston disposed co-axially with said sleeve, an interior base of said piston in contact with said comestible, said piston disposed in press-slidable complemental relationship to an interior surface of said sleeve, said piston secured in fluid tight relationship to said opposing sleeve periphery; and
(e) between said sleeve proximally to said second end of said axis, means for manual release of said piston from said sleeve.

12. The system as recited in claim 11 in which said manual release means comprises a scored circumference.
